(19) United States
(12) Patent Application Publication
(10) Pub. No.: US 2017/0277689 A1
(43) Pub. Date: Sep. 28, 2017

(54) SOCIAL NETWORK SERVICE SYSTEM AND SOCIAL NETWORK SERVICE METHOD USING THE SAME

(71) Applicant: Demian Lab, Gwangju (KR)

(72) Inventor: Myung Gu KIM, Seoul (KR)

(21) Appl. No.: 15/391,227

(22) Filed: Dec. 27, 2016

(30) Foreign Application Priority Data
Mar. 28, 2016 (KR) 10-2016-0036655

(51) Int. Cl. G06F 17/30; G06K 9/62

(52) U.S. Cl. CPC G06F 17/3028; G06K 9/6215; G06F 17/30778; G06F 17/30752; G06F 17/30867; H04L 67/20

(57) ABSTRACT

Provided are a social network service system and a social network service method using the same. The social network service system includes a communication terminal configured to transmit an upload image that is photographed through a camera module or is included in the communication terminal together with information data for social networking, and a management server configured to receive the upload image and the information data for social networking from the communication terminal and to store the received upload image and the received information data for social networking, wherein the management server selects music information suitable for the upload image and stores the music information together with the upload image.

### CROSS-REFERENCE TO RELATED APPLICATION

This application claims priority to and the benefit of Korean Patent Application No. 10-2016-0036655, filed on Mar. 28, 2016, the disclosure of which is incorporated herein by reference in its entirety.

### BACKGROUND

1. Field of the Disclosure

The present invention relates to a social network service system and a social network service method using the same, and more particularly, to a social network service system capable of automatically selecting and providing music that is suitable for an image uploaded by a user, and a social network service method using the same.

2. Discussion of Related Art

Recently, with development of communication technologies, there has also been development of devices for forming a social relationship between individuals. In particular, media, called a web, which has emerged with development of Internet technology, build a network through a personal computer PC so that users can interact with each other regardless of time and place, thus removing temporal and spatial limitations at the same time.

The development of Internet technology has led to providing a service that allows individuals to establish relationships with other people in their own virtual space on the Internet, that is, a service for providing communication and sharing various types of information. Such a service is referred to as a social network service (SNS).

Representatives examples of the SNS include mini homepies (an abbreviation of homepage), blogs, café s, and Twitter, which are provided by Internet service providers (ISP) and with which Internet users may make a human network while sharing information or communicating with each other or may form a new relationship by making community spaces according to themes with regard to fields of interest.

However, in the conventional social network service system, when an uploaded image is desired to be provided together with music, a user needs to directly select music suitable for the image and upload a music file together with the image on a management server, thus having inconvenience.

### RELATED ART DOCUMENT

### Patent Document

Korean Unexamined Patent Application Publication No. 10-2015-0058710: Social Network System that Implements Image Sliding Output

### SUMMARY OF THE DISCLOSURE

The present invention is directed to a social network service system in which when an image is uploaded, music suitable for the image is automatically selected and provided, and a social network service method using the same.

To achieve the above-described objectives, according to an aspect of the present invention, there is provided a social network service system including a communication terminal and a management server. The communication terminal may be configured to transmit an upload image that is photographed through a camera module or is included in the communication terminal together with information data for social networking. The management server may be configured to receive the upload image and the information data for social networking from the communication terminal and to store the received upload image and the received information data for social networking, wherein the management server selects music information suitable for the upload image and stores the music information together with the upload image.

The management server may include a server communication module configured to receive the upload image and the information data for social networking from the communication terminal, a database configured to store the upload image and the information data for social networking that are received from the server communication module, and a music determiner configured to select music information suitable for the upload image received from the server communication module and to store the selected music information together with the upload image in the database.

The music determiner may select the music information that is suitable for at least one of a landmark, an animal, an object, and a facial expression of a human that are included in the upload image.

The music determiner may include a sample memory configured to store a plurality of sample images related to at least one of landmarks of various places, animals, objects, and facial expressions of humans, a music memory configured to store a plurality of pieces of music information that are previously set to match the sample images, respectively, an image identifying module configured to determine a sample image among the sample images stored in the sample memory, which is similar to a subject included in the upload image received through the server communication module, and a music storing module configured to store music information among the plurality of pieces of music information stored in the music memory, which matches the sample image determined through the image identifying module, together with the upload image in the database.

The communication terminal may further include a position sensing module configured to sense position information at which the upload image is photographed in photographing through the camera module to generate the upload image, and transmit the sensed position information sensed by the position sensing module together with the upload image to the management server. The music determiner may include: a music memory configured to store a plurality of pieces of music information; and a music storing module configured to determine music information among the plurality of pieces of music information stored in the music memory, which matches the upload image according to a matching algorithm that is preset based on the position information of the upload image received from the communication terminal, and to store the determined music information together with the upload image in the database.

According to another aspect of the present invention, there is provided a social network service method including: transmitting an upload image that is photographed through a camera module of a communication terminal or is included in the communication terminal together with information data for social networking; receiving, by a management server, the upload image and the information data for social networking; selecting music information suitable for the upload image received in the receiving of the upload image and the information for social networking; and storing the music information selected in the selecting of music information and the upload image together with the information data for social networking in a database of the management server.

The selecting of music information may include: identifying a part related to a subject in the upload image received from the communication terminal; determining a sample image which is similar to the subject included in the upload image, among sample images stored in a sample memory; and selecting music information that matches the sample image determined in the determining of a sample image from a music memory in which a plurality of pieces of music information are previously set to match the sample images stored in the sample memory, respectively.

The transmitting of the image may include transmitting position information at which the upload image is photographed together with the upload image to the management server through a position sensing module provided in the communication terminal; and the selecting of music information may include selecting music information among the plurality of pieces of music information stored in the music memory, which matches the upload image according to a matching algorithm that is preset based on the position information received from the communication terminal

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating a social network service system according to an exemplary embodiment of the present invention; and

FIG. 2 is a block diagram illustrating a social network service system according to another exemplary embodiment of the present invention.

### DETAILED DESCRIPTION OF EXEMPLARY EMBODIMENTS

Hereinafter, a social network system and a social network service method using the same will be described with reference to the accompanying drawings. Since the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures. In the drawings, the sizes and relative sizes of layers and regions may be exaggerated for clarity.

It should be understood that although the terms “first,” “second,” “third,” etc. may be used herein to describe various elements, components, regions, layers, and/or sections, these elements, components, regions, layers, and/or sections are not limited by these terms. These terms are used to only distinguish one element, component, region, layer, or section from another element, component, region, layer, or section. Thus, a first element, component, region, layer or section discussed below could be referred to as a second element, component, region, layer, or section without departing from the teachings of the present inventive concept.

The terminology used herein is for the purpose of describing particular embodiments only and is not intended to be limiting of the present inventive concept. As used herein, the singular forms “a,” “an,” and “the” are intended to include the plural forms as well unless clearly indicated otherwise by context. It should be further understood that the terms “comprises” and/or “comprising,” specify the presence of stated features, integers, steps, operations, elements, and/or components when used in this specification, but do not preclude the presence or addition of one or more other features, integers, steps, operations, elements, components, and/or groups thereof.

All terms (including technical and scientific terms) used herein have the same meanings as commonly understood by one of ordinary skill in the art to which this inventive concept belongs unless defined otherwise. It should be further understood that terms, such as those defined in commonly used dictionaries, should be interpreted as having a meaning that is consistent with their meaning in the context of the relevant art and are not to be interpreted in an idealized or overly formal sense unless expressly so defined herein.

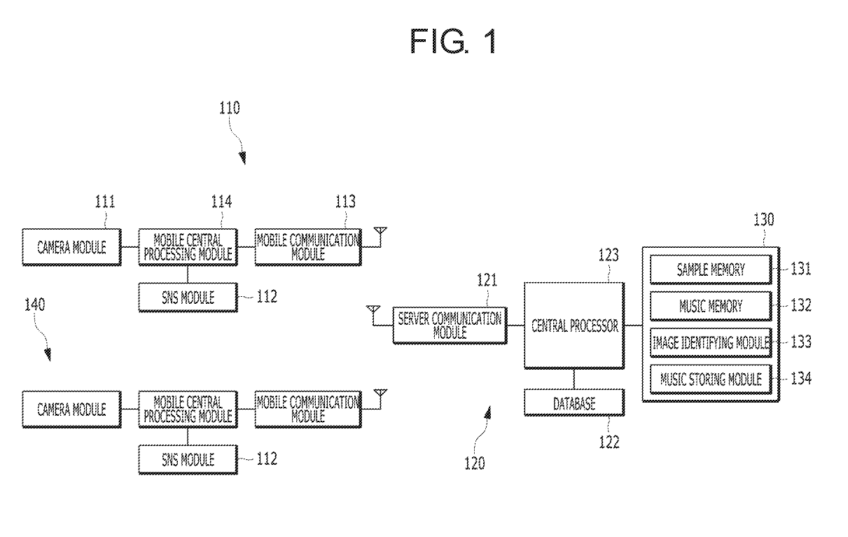

FIG. 1 is a block diagram illustrating a social network service system 100 according to an exemplary embodiment of the present invention.

Referring to FIG. 1, the social network service system 100 includes: a communication terminal 110 configured to transmit an image, which is photographed through a camera module 111 or is included in the communication terminal 110, together with information data for social networking; and a management server 120 configured to receive the upload image and the information data for social networking from the communication terminal 110 and to store the received upload image and the received information data for social networking, while selecting music information suitable for the upload image and storing the music information together with the upload image.

The communication terminal 110 is a mobile device that is generally used, e. g. a smartphone, and includes the camera module 111, a SNS module 112, a mobile communication module 113, and a mobile central processing module 114.

The camera module 111 is installed on a main body of the communication terminal 110 to photograph outside of the communication terminal 110 according to a manipulation of a user. The camera module 111 is a photographing device that is generally used, and thus, description thereof is omitted.

The SNS module 112 is an application program that supports a social network service, for example, supporting viewing of images and files that are uploaded through the management server 120 between registered users. The SNS module 112 may be provided using various applications that are generally known to the public, for example, Twitter, Facebook, Instagram, and so on. In this case, the information data for social networking may be provided using comments that are written by a user related to an upload image, for example, a comment submitted by a user who has uploaded the image or a reply submitted by a third party who has viewed the upload image.

The mobile communication module 113 serves to perform data transmission/reception with the management server 120 through a wireless communication network. The mobile communication module 113 performs signal processing on user information and upload images to be suitable for data transmission and transmits the user information and upload images having been subjected to the signal processing to the management server 120, and converts a signal received from the management server 120 into data that is configured to be output through the communication terminal 110.

The mobile central processing module 114 is configured to control the camera module 111, the SNS module 112, and the communication module 113 according to user control, and may also execute general processes of a mobile communication terminal, such as phone call function setting, short message service (SMS), multimedia messaging service (MMS), and Internet connection.

The management server 120 includes a server communication module 121 configured to receive the upload image and the information data for social networking from the communication terminal 110; a database 122 configured to store the upload image and the information data for social networking received from the server communication module 121; a music determiner 130 configured to select music information suitable for the upload image received from the server communication module 121 and store the selected music information together with the upload image in the database 122; and a central processor 123 configured to, when a communication terminal 140 of a third party requests the upload image stored in the database 122, transmit the upload image and information data for social networking together with the music information selected by the music determiner 130 to the communication terminal 140 of the third party through the server communication module 121.

The server communication module 121 performs data transmission/reception with the communication terminal 110 and the communication terminal 140 of the third party while corresponding to the mobile communication module 113. The server communication module 121 converts a signal related to user information, an upload image, and position information at which the upload image has been photographed, which are transmitted from the communication terminal 110, into data suitable for storing and processing.

The database 122 stores an upload image, position information at which the upload image is photographed, user information, and information data for social networking that are provided from the communication terminal 110.

The music determiner 130 selects the music information that is suitable for at least one of a landmark, an animal, an object, and a facial expression of a human that are included in the upload image. The music determiner 130 includes a sample memory 131, a music memory 132, an image identifying module 133, and a music storing module 134.

The sample memory 131 stores sample images of landscapes of various locations, animals, objects, or facial expressions of humans. The sample images may be provided using landmarks of various countries, topographical images such as famous forests, oceans, and rivers, images of animals, such as dogs and cats, images of objects, such as a flowerpot, a computer, and a coffee cup, and images of facial expressions of humans, such as a smiling face or crying face.

The music memory 132 stores a plurality of pieces of music information, the plurality of pieces of music information matching the sample images, respectively. For example, the music memory 132 stores music information containing sounds made by birds or animals that match a sample image regarding a forest, music information containing a Korean traditional song that matches a sample image regarding a Korean-style house (hanok). In this case, a sample image matching respective music information is previously set.

The image identifying module 133 determines a sample image which is similar to a subject included in the upload image received through the server communication module 121 among the sample images stored in the sample memory 131.

The image identifying module 133 distinguishes and identifies a subject in the upload image provided from the communication terminal 110. Then, the image identifying module 133 selects a sample image which is similar to the subject in the upload image among sample images stored in the sample memory 131. The image identifying module 133 may be provided similar to the general image search program made by Google, thus, description thereof is omitted.

The music storing module 134 stores music information which matches the sample image determined through the image identifying module 133 among the plurality of pieces of music information stored in the music memory 132 together with the upload image in the database 122. For example, when an image uploaded through the image identifying module 133 is determined to be similar to a sample image regarding a forest, the music storing module 134 copies a music file containing sounds made by birds or animals that are set to match the sample image regarding forests from the music memory 132, and stores the copied music file together with the upload image in the database 122.

When the communication terminal 140 of the third party requests the upload image stored in the database 122, the central processor 123 transmits the upload image stored in the database, information data for social networking, and music information to the communication terminal 140 of the third party through the server communication module 121. When the third party selects an upload image displayed on a SNS module 112 of the communication terminal 140 of the third party, the communication terminal 140 of the third party transmits a request signal for viewing the upload image to the management server 120, and the central processor 123 transmits the upload image, music information that matches the upload image, and information data for social networking to the communication terminal 140 of the third party. In this case, if the third party enters other information data for social networking, such as a reply, through the SNS module 112 of the communication terminal 140, the entered information data for social networking is stored together with information data for social networking that is previously stored in the management server 120.

Meanwhile, hereinafter, a social network service method using the above described social network service system 100 according to the present invention will be described in detail. The social network service method according to the present invention includes transmitting an image; receiving information; selecting music; storing; and providing information.

The transmitting of an image refers to transmitting an upload image that is photographed through the camera module 111 of the communication terminal 110 or is included in the communication terminal 110 together with information data for social networking to the management server 120. A user may transmit the upload image and the information data for social networking to the management server 120 through a wireless communication network by using the mobile communication module 113 of the communication terminal 110.

The receiving of information refers to receiving, by the management server 120, the upload image and the information data for social networking. The server communication module 121 of the management server 120 receives the upload image and the information data for social networking that are transmitted from the communication terminal 110.

The selecting of music refers to selecting music information that is suitable for the upload image received in the receiving of information. The selecting of music includes identifying a subject, determining an image, and selecting.

The identifying of a subject refers to identifying a subject in the upload image provided from the communication terminal 110. The image identifying module 133 of the music determiner 130 distinguishes a subject from the upload image.

The determining of an image refers to determining, by the image identifying module 133, a sample image that is similar to a part corresponding to the subject included in the upload image, among various sample images stored in the sample memory 131.

The selecting refers to selecting music information that matches the sample image determined in the determining of the image from the music memory 132 that stores a plurality of pieces of music information previously set to match the respective sample images stored in the sample memory 131. In this case, the music storing module 134 selects the music information.

The storing refers to storing the upload image and the music information selected in the selecting of music together with the information data for social networking in the database 122 of the management server 120. The music storing module 134 stores the selected music information together with the upload image in the database 122.

The providing of information refers to, when the storing is completed and the communication terminal 140 of the third party requests the stored upload image, transmitting the information data for social networking and the music information together with the upload image to the communication terminal 140 of the third party. The central processor 123 of the management server 120 transmits the upload image, the information data for social networking, and the music information to the communication terminal 140 of the third party through a wireless communication network upon a request of the communication terminal 140 of the third party. In this case, the communication terminal 140 of the third party may output the upload image, the information data for social networking, and the music information provided from the management server 120 to the user, through the SNS module 112 included in the communication terminal 140.

The social network service system 100 according to the present invention and the social network service method using the same as described above is provided to, when uploading an image to a management server, store music information that is suitable for the image together with the image in the management server, thereby omitting a task of a user selecting and uploading music, thus ensuring convenience in use.

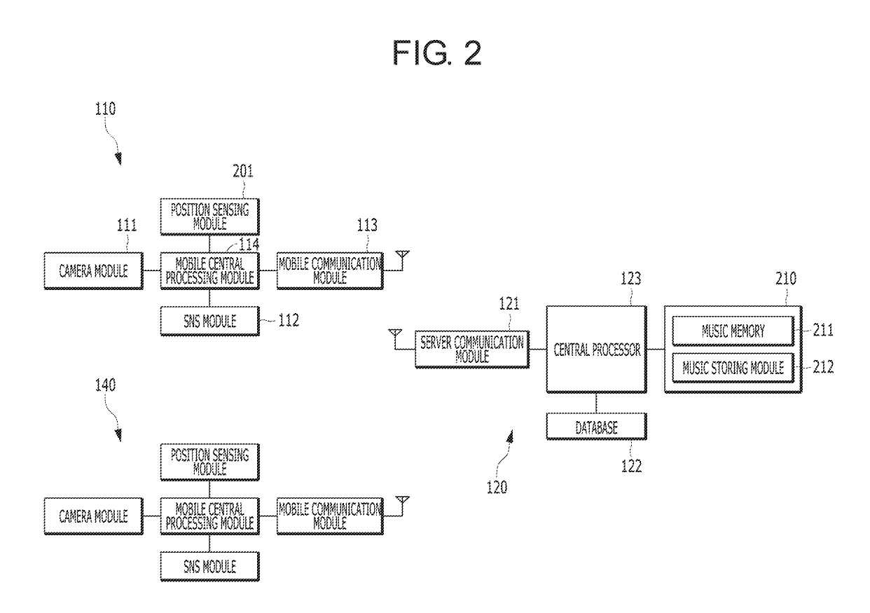

FIG. 2 is a block diagram illustrating a social network service system 200 according to another exemplary embodiment of the present invention.

The same reference numerals will be assigned to the elements having functions identical to those of the elements described above.

Referring to FIG. 2, the communication terminal 110 of the social network service system 200 further includes a position sensing module 201 configured to sense position information at which a upload image is photographed in photographing through the camera module 111 to generate the upload image, and the communication terminal 110 transmits the position information sensed by the position sensing module 201 together with the upload image to the management server 120.

The position sensing module 201 is configured to measure an absolute position of the communication terminal 110 and provide the measured absolute position to the management server 120. The position sensing module 201 may measure an absolute position of the communication terminal 110 using satellite navigation services, such as a global positioning system (GPS), differential GPS, Galileo, and so on, or using triangulation of base stations that control the communication terminal 110.

In this case, a music determiner 210 includes a music memory 211 and a music storing module 212.

The music memory 211 stores a plurality of pieces of music information. The music information is provided using sounds made by birds, sounds made by animals, the sound of water, and traditional music of Korea or other various countries which are music suitable for landscape.

The music storing module 212 determines music information among the plurality of pieces of music information stored in the music memory 211 that match the upload image according to a matching algorithm that is preset based on position information of the upload image received from the communication terminal 110, and stores the determined music information together with the upload image in the database 122.

For example, the music storing module 212 is configured to, when the position information of the upload image relates to a forest, select music information containing sounds made by birds or animals among the plurality of pieces of music information stored in the music memory 211. Also, the music storing module 212 is configured to, when the position information of the upload image relates to a theme park, such as a Hanok Village, select music information containing pansori or Korean traditional music that matches the theme park.

The music information selected by the music storing module 212 is stored together with the upload image in the database 122, and when the communication terminal 140 of the third party sends the management server 120 a request signal for viewing the upload image, the management server 120 transmits the music information together with the upload image and the information data for social networking to the communication terminal 140 of the third party.

Meanwhile, hereinafter, a social network service method using the above-described social network service system 200 will be described in detail. The social network service method includes transmitting an image; receiving information; selecting music; storing; and providing information.

The transmitting of an image refers to transmitting an upload image that is photographed through the camera module 111 of the communication terminal 110 or is included in the communication terminal 110 together with information data for social networking to the management server 120. A user may transmit the upload image and the information data for social networking to the management server 120 through a wireless communication network by using the mobile communication module 113 of the communication terminal 110.

In this case, the communication terminal 110 may transmit position information at which the upload image is photographed together with the upload image to the management server 120 through the position sensing module 201. The receiving of information refers to receiving, by the management server 120, the upload image and the information data for social networking. The server communication module 121 of the management server 120 receives the upload image and the information data for social networking that are transmitted from the communication terminal 110.

The selecting of music refers to selecting music information that is suitable for the upload image received in the receiving of information. In this case, the music storing module 212 may select music information among a plurality of pieces of music information stored in the music memory 211 that match the upload image according to a matching algorithm that is preset based on the position information received from the communication terminal 110

The storing refers to storing the upload image and the music information selected in the selecting of music together with the information data for social networking in the database 122 of the management server 120. The music storing module 212 stores the selected music information together with the upload image in the database 122.

The providing of information refers to, when the storing is completed and the communication terminal 140 of the third party requests the stored upload image, transmitting the information data for social networking and music information together with the upload image to the communication terminal 140 of the third party. The central processor 123 of the management server 120 transmits the upload image, the information data for social networking, and the music information to the communication terminal 140 of the third party through a wireless communication network upon a request of the communication terminal 140 of the third party. In this case, the communication terminal 140 of the third party may output the upload image, the information data for social networking, and the music information provided from the management server 120 to the user, through the SNS module 112 included in the communication terminal 140.

As is apparent from the above, the social network service system according to the present invention and the social network service method using the same can store music information that matches an image in a management server when the image is uploaded on a management server, so that a task of a user selecting and uploading music is omitted, thus ensuring convenience in use.

The description suggests the best mode of the present invention to provide an example that explains the present invention and also enables one skilled in the art to manufacture and use the present invention. The specification drafted as such is not limited to detailed terms suggested in the specification. Accordingly, it will be apparent to those skilled in the art that various modifications, changes, and variations may be made in the embodiments without departing from the scope of the invention. Accordingly, the scope of the present invention should be defined not by the embodiments but by the claims, but should be interpreted in the widest scope in consistent with the principles and novel features disclosed herein.

What is claimed is:

1. A social network service system comprising:
a communication terminal configured to transmit an upload image that is photographed through a camera module or is included in the communication terminal together with information data for social networking; and
a management server configured to receive the upload image and the information data for social networking from the communication terminal and to store the received upload image and the received information data for social networking, wherein the management server selects music information suitable for the upload image and stores the music information together with the upload image.

2. The social network service system of claim 1, wherein the management server comprises:
a server communication module configured to receive the upload image and the information data for social networking from the communication terminal;
a database configured to store the upload image and the information data for social networking that are received from the server communication module; and
a music determiner configured to select music information suitable for the upload image received from the server communication module and to store the selected music information together with the upload image in the database.

3. The social network service system of claim 2, wherein the music determiner selects the music information that is suitable for at least one of a landmark, an animal, an object, and a facial expression of a human that are included in the upload image.

4. The social network service system of claim 3, wherein the music determiner comprises:
a sample memory configured to store a plurality of sample images related to at least one of landmarks of various places, animals, objects, and facial expressions of humans;
a music memory configured to store a plurality of pieces of music information that are previously set to match the sample images, respectively;
an image identifying module configured to determine a sample image among the sample images stored in the sample memory, which is similar to a subject included in the upload image received through the server communication module; and
a music storing module configured to store music information among the plurality of pieces of music information stored in the music memory, which matches the sample image determined through the image identifying module, together with the upload image in the database.

5. The social network service system of claim 2, wherein the communication terminal further includes a position sensing module configured to sense position information at which the upload image is photographed in photographing through the camera module to generate the upload image, and the communication terminal transmits the sensed position information sensed by the position sensing module together with the upload image to the management server,
wherein the music determiner comprises:
a music memory configured to store a plurality of pieces of music information; and
a music storing module configured to determine music information among the plurality of pieces of music information stored in the music memory, which matches the upload image according to a matching algorithm that is preset based on the position information of the upload image received from the communication terminal, and to store the determined music information together with the upload image in the database.

6. A social network service method comprising:
transmitting an upload image that is photographed through a camera module of a communication terminal or is included in the communication terminal together with information data for social networking;
receiving, by a management server, the upload image and the information data for social networking;
selecting music information suitable for the upload image received in the receiving of the upload image and the information for social networking; and
storing the music information selected in the selecting of music information and the upload image together with the information data for social networking in a database of the management server.

7. The social network service method of claim 6, wherein the selecting of music information comprises:
identifying a part related to a subject in the upload image received from the communication terminal;
determining a sample image which is similar to the subject included in the upload image, among sample images stored in a sample memory; and
selecting music information that matches the sample image determined in the determining of a sample image from a music memory in which a plurality of pieces of music information are previously set to match the sample images stored in the sample memory, respectively

8. The social network service method of claim 6 wherein
the transmitting of the image comprises transmitting position information at which the upload image is photographed together with the upload image to the management server through a position sensing module provided in the communication terminal; and
the selecting of music information comprises selecting music information among the plurality of pieces of music information stored in the music memory, which matches the upload image according to a matching algorithm that is preset based on the position information received from the communication terminal.
